(19) United States
(12) Patent Application Publication
(10) Pub. No.: US 2010/0254587 A1
(43) Pub. Date: Oct. 7, 2010

(54) METHOD FOR SEGMENTING AN INTERIOR REGION OF A HOLLOW STRUCTURE IN A TOMOGRAPHIC IMAGE AND TOMOGRAPHY SCANNER FOR PERFORMING SUCH SEGMENTATION

(76) Inventors: Lutz Gündel, Erlangen (DE); Friedrich Knoth, Herzogenaurach (DE)

Correspondence Address: HARNESS, DICKEY & PIERCE, P.L.C., P.O.BOX 8910, RESTON, VA, 20195, US

(21) Appl. No.: 12/753,956

(22) Filed: Apr. 5, 2010

(30) Foreign Application Priority Data
Apr. 7, 2009 (DE) 10 2009 016 793.5

(51) Int. Cl. G06K 9/00

(52) U.S. Cl. 382/131

(57) ABSTRACT

A multistage method, according to at least one embodiment of the invention, is disclosed for segmenting an interior region of a hollow structure in a tomographic image. In at least one embodiment of the method, portions of the image are segmented in each of at least two segmentation cycles, respectively, whilst using a substance-specific segmentation criterion. Using this procedure, the interior region of the hollow structure can be completely determined, even in the case where a plurality of substances with different imaging properties, e.g. with different attenuation properties, are present.

### PRIORITY STATEMENT

The present application hereby claims priority under 35 U.S.C. §119 on German patent application number DE 10 2009 016 793.5 filed Apr. 7, 2009, the entire contents of which are hereby incorporated herein by reference.

### FIELD

At least one embodiment of the invention generally relates to a method for segmenting an interior region of a hollow structure in a tomographic image and/or a tomography scanner for performing such segmentation.

### BACKGROUND

In medical technology, the use of tomography scanners affords the visualization for diagnostic and/or therapeutic purposes of hollow structures such as e.g. intestinal or vessel structures or structures of the bronchi in a tomographic image generated by the tomography scanner. By way of example, computed tomography scanners, angiography scanners or magnetic resonance imaging scanners are used as tomography scanners for generating two- or three-dimensional images in the form of slice or volume images. In the case of a virtual colonography for examining the intestines and in the case of a virtual angiography for examining vessels, wall areas are examined for conspicuous anatomy, as is present in the case of e.g. a polyp or a tumor. However, without implementing further measures, the hollow structures are difficult to recognize because they have similar imaging properties in the tomographic image as the surrounding tissue.

A suitable contrast agent is used to increase the visible contrast. By way of example, a contrast agent with significantly higher or lower attenuation than the surrounding tissue is used in X-ray imaging. It is for this reason that the intestines are filled with air or carbon dioxide as a contrast agent in virtual colonography.

Due to the low attenuation of the X-ray radiation by air or carbon dioxide, the portions of the interior of the intestines filled with contrast agent are clearly visible in the image, having CT numbers of less than −800 HU. By contrast, a contrast agent with high attenuation of the X-ray radiation is used in virtual angiography. It is for this reason that the portions filled with a contrast agent are imaged with very high CT numbers in the generated tomographic images. In both cases, the portions indicated by the contrast agent are imaged in the tomographic image with high signal deviation from neighboring structures. They thus can be segmented by a simple thresholding method. The intestinal or vessel walls can easily be recognized in the tomographic image using a transparent, semi-transparent or colored visualization of the portions.

However, a general problem resides in the fact that not only the administered contrast agent but also other substances are found in the interior region of the hollow structures. Thus, for example, stool remains are also found in the intestines and blood or calcium deposits are also found in the vessels in addition to the contrast agent. Compared to the contrast agent, these substances have different imaging properties during imaging. In X-ray imaging, the interior region of the hollow structures cannot be detected entirely by a simple thresholding criterion due to the different attenuation properties of these substances compared to X-ray radiation. The undetected additional substances lead to the wall regions of the hollow structure being covered. In these regions, diagnosis or treatment planning is impossible, or at the very least impeded.

### SUMMARY

In at least one embodiment of the present invention, a method is specified for segmentation, by which the interior region of a hollow structure can be segmented in an improved fashion should substances with different imaging properties be present. In at least one embodiment of the present invention, a tomography scanner designed for such segmentation is also specified.

A method is for segmenting an interior region of a hollow structure in a tomographic image in at least one embodiment. Advantageous refinements of the method are the subject matter of dependent claims. Furthermore, at least one embodiment of the invention is achieved by a tomography scanner. An advantageous refinement of the tomography scanner is the subject matter of the dependent claim.

According to at least one embodiment of the invention, the method for segmenting an interior region of a hollow structure in a tomographic image comprises at least two segmentation cycles, wherein portions of the interior region are segmented in each cycle, respectively whilst using a substance-specific segmentation criterion.

The multistage segmentation method affords segmentation of the entire interior region of the hollow structure with almost no gaps, even if the substances present in the interior region have different imaging properties. The entire interior region is formed by merging the portions segmented in the cycles. An appropriate visualization of the tomographic image, in which the portions or the interior region assembled from the portions is illustrated in color, transparently or semi-transparently, affords a view of the interior wall of the hollow structure even in those regions in which it is not contrast agent but other substances that are present, such as e.g. stool remains in the case of colonography or blood and plaque in the case of angiography. Moreover, the actual hollow structure also can be detected on the basis of the entirely segmented interior region. By way of example, this can be possible by extending the segmented interior region by a prescribable number of pixels by means of morphological operators. Since the same method steps are used during the segmentation in each segmentation cycle and said steps only differ by being carried out using a different substance-specific segmentation criterion, the method can be implemented very easily and efficiently in real time on an image processing system.

In a particularly advantageous refinement of at least one embodiment of the invention, the portions are indexed by assigning an index dependent on the cycle to each pixel in the respective portion for characterizing a potential substance assignment.

Indexing the segmented portions provides the preconditions for improved visualization by being able to illustrate portions segmented in different cycles, and thus potentially belonging to different substances, in different fashions. Using this, an observer can immediately distinguish between the individual substances when the portions are displayed differently. In the case of colonography, it is possible to distinguish between the contrast agent and the stool remains using e.g. a colored, transparent or semi-transparent display when visualizing the portions from the two segmentation cycles.

In an advantageous refinement of at least one embodiment of the invention, the segmented portions are extended and/or closed by a prescribable number of pixels by means of morphological image operators before carrying out the indexing. This can close gaps in the portions caused by image noise.

After the segmentation cycles have passed, each pixel of a respective missing region without an index assignment preferably is assigned an index from one of the adjoining portions in order to fill missing regions. Thus, a missing region is defined as an image region in which no pixel was assigned an index in one of the segmentation cycles. This procedure can fill gaps between portions that were not segmented in one of the segmentation cycles but belong to one of the adjoining portions or substances. By way of example, such gaps can be created by the CT number assigned to a pixel being too low or too high in comparison with the actual substance due to partial volume effects. The filling is performed on the basis of the results of the indexing of locally neighboring portions without additional evaluation of the image information in the tomographic image being necessary, and so this can be implemented with little computational complexity.

For filling the missing regions, the assignment preferably is carried out dependent on a boundary line determined in the respective missing region, by means of which line the adjoining portions are separated. By way of example, the boundary line can represent a centerline. However, it would likewise be conceivable that, for filling the missing regions, the assignment advantageously is carried out dependent on a determined distance of the pixel from the adjoining portions. By way of example, the pixel is assigned the index of the portion that is the closest neighbor to said pixel.

The assignment between a pixel from the missing region and an index preferably is only carried out if the smallest determined distance is not greater than a predetermined threshold. The further the pixel is arranged from a portion, the more unlikely it becomes that it belongs to the same substance. Therefore, this distance threshold expediently is only a few pixels. Thus, this procedure reduces the number of false assignments.

In order to clean up overlap regions, where at least two indices are assigned to each pixel, a further advantageous refinement of at least one embodiment of the invention provides for each pixel to have one index selected for it from the index assignments after the segmentation cycles have passed and only this selected index is assigned to the pixel. Thus, an overlap region is defined as an image region in which each pixel was assigned an index a number of times during the cycles. The clean up avoids multiple assignments. It is thus ensured that every pixel only characterizes one potential substance association after the segmentation is complete. In particular, this avoids conflicts in the subsequent visualization.

As in the case of filling, the assignment during the clean up is carried out dependent on a boundary line determined in the respective overlap region, wherein the boundary line separates the adjoining portions. Accordingly, for cleaning up, the assignment advantageously is likewise carried out dependent on a determined distance of the pixel from image regions of the portions without overlap.

Advantageously, a thresholding criterion is used as substance-specific segmentation criterion. Therefore, this is a simple comparison of a CT number assigned to the pixel with a threshold, which can be implemented easily using only few calculation operations.

In an advantageous development of at least one embodiment of the invention, the thresholding criterion checks pixel-by-pixel whether an attenuation value assigned to the respective pixel lies within an attenuation interval by comparison with an upper and lower threshold. Such thresholding criteria are particularly well suited to detecting contrast agent or stool remains that are very homogenous and have almost constant densities.

The tomography scanner according to at least one embodiment of the invention for segmenting an interior region of a hollow structure in a tomographic image comprises corresponding at least one device for segmenting portions of the interior region using a substance-specific segmentation criterion and preferably at least one device for indexing the portions, by which every pixel in the portions can be assigned an index for characterizing a potential substance assignment. Furthermore, provision is made for corresponding at least one device for performing the segmenting and indexing with different substance-specific segmentation criteria in a cyclical fashion.

### BRIEF DESCRIPTION OF THE DRAWINGS

Example embodiments of the invention and further advantageous refinements of the invention as per the dependent claims are illustrated in the following schematic drawings, in which

FIG. 1 shows a side view of a CT scanner, which is suitable for carrying out the method according to at least one embodiment of the invention for segmentation,

FIG. 2 shows a procedure for the method according to at least one embodiment of the invention for segmentation, in the form of a flowchart,

FIG. 3 shows a tomographic image in which a cross section through the intestines is visualized, and

FIG. 4 shows the tomographic image shown in FIG. 3 with segmented portions.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

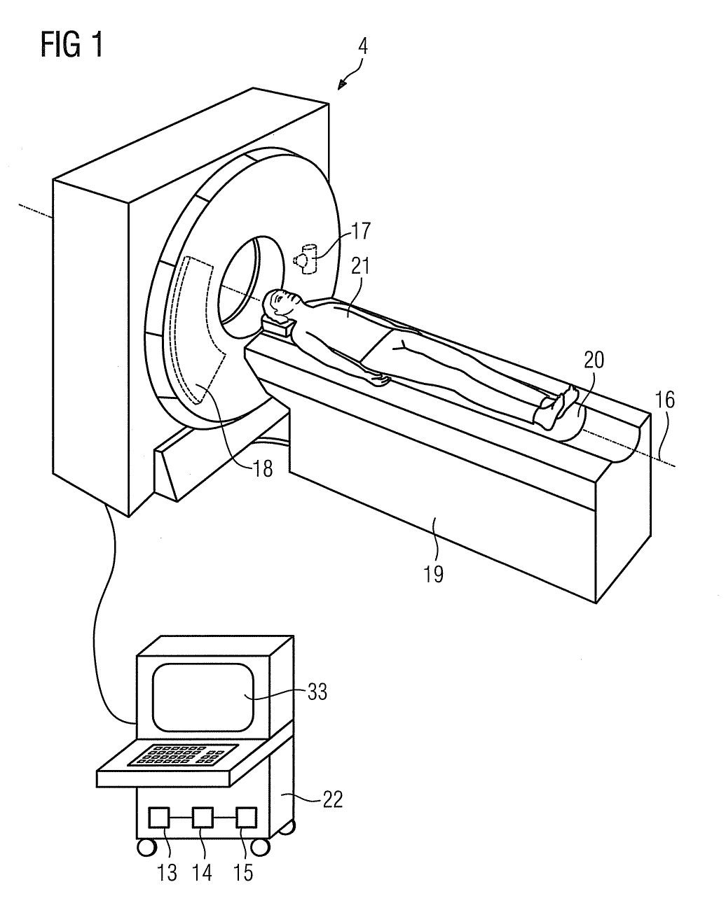

FIG. 1 shows a perspective view of a tomography scanner, in this case a computed tomography scanner 4, which is suitable for carrying out the method according to the invention for segmenting an interior region 1 of a hollow structure 2 in a tomographic image 3.

A recording system 17, 18, which can register projections of an examination region from a multiplicity of different projection directions, is located in the interior of the computed tomography scanner 4 and is arranged on a gantry (not illustrated) such that it can rotate about a system axis 16.

The computed tomography scanner 4 is assigned a bearing apparatus 19 with a moveable patient couch 20, on which the patient 21 lies. The patient couch 20 is arranged such that it can be adjusted in the direction of the system axis 16 and so the examination region connected to the patient 21 can be moved into the measurement region of the recording system 17, 18 through an opening in the housing of the gantry.

The recording system 17, 18 has an emitter in the form of an X-ray tube 17 and a detector 18 arranged opposite thereto for registering projections. The detector 18 has an arc-shaped design and comprises a plurality of detector elements aligned so as to form a detector row. The X-ray tube 17 generates radiation in the form of a fan-shaped X-ray beam bundle, which penetrates the measurement region of the recording system 17, 18. Such systems are also available with a plurality of recording systems, which are arranged around the first recording system, offset by a fixed angle. The X-ray radiation subsequently impinges on the detector elements and generates a CT value or attenuation value, specified in the form of a CT number in Hounsfield units or HU, which is dependent on the attenuation of the X-ray radiation. By way of example, the X-ray radiation is converted into attenuation values by way of a photodiode optically coupled to a scintillator or by way of a direct-conversion semiconductor.

The set of attenuation values generated in this fashion is recorded for every projection direction set. In the case of a helical scan, there is a rotation of the gantry during a simultaneous continuous feed of the patient 21 in the direction of the system axis 16. This registers projections at different positions along the examination region in a helical fashion from a multiplicity of different projection directions. The projections obtained thus are transmitted to a computational unit 22 and are, step-by-step, added to form a tomographic image, e.g. a slice or volume image.

If needed, a contrast agent can be administered to the patient 21 for examining a hollow structure 2, e.g. the intestines, the vessels or the bronchi, which contrast agent increases the visible contrast with respect to the surrounding soft tissue. In the case of a virtual colonography, a gaseous contrast agent, e.g. air or carbon dioxide, for example can be supplied to the intestines of the patient 21. Due to the low attenuation of the X-ray radiation by the contrast agent, the image regions containing the contrast agent are imaged with CT numbers of less than −800 HU. The object of administering the contrast agent is to generate a sufficiently good contrast between the contents of the intestines and the intestinal wall such that in a subsequent visualization of the intestines, the intestinal walls can be examined for conspicuous anatomy, as is present in the case of polyps or tumors. In the process, the utilized contrast agent is selected such that it is highlighted with respect to the adjoining substances and structures in the tomographic image 3 by high signal deviation. It therefore can easily be segmented using a contrast-agent-specific segmentation criterion.

As mentioned previously, a particular problem of virtual colonography resides in the intestines also containing other substances, particularly stool remains, in addition to the actual contrast agent and these other substances have different attenuation properties compared to the contrast agent and surrounding tissue. These circumstances are illustrated in FIG. 3. The tomographic image 3 shows a cross section of a hollow structure 2, namely intestines, which, in the interior region 2, has contrast agent in a first image region 23 and stool remains in a second image region 24.

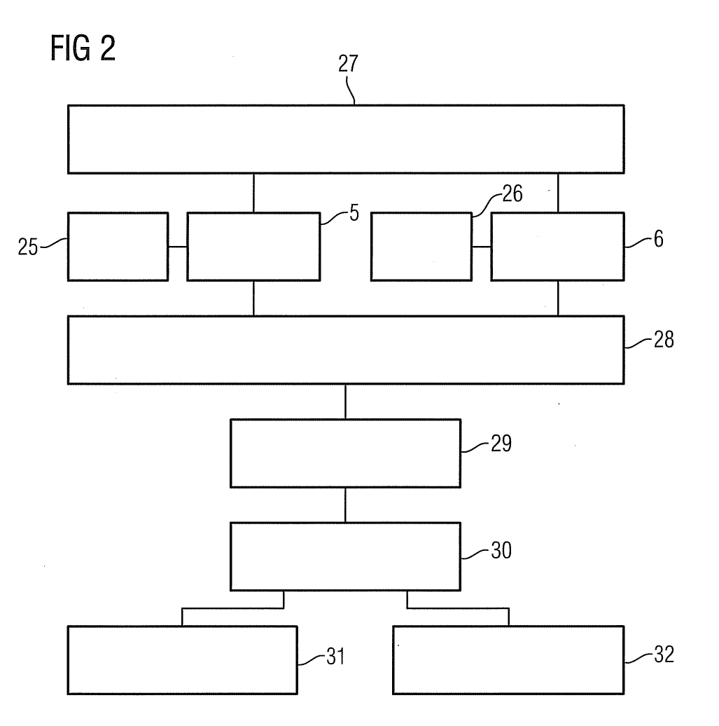

In the general case, N segmentation cycles 5, 6 are required for segmenting the interior region 1 in the presence of N different substances, as is shown by the flowchart in FIG. 2. In the present situation, the interior region 1 of the intestines is segmented using a two-stage segmentation method, i.e. with N=2 segmentation cycles. The tomography scanner 4 has corresponding means 13 for segmentation.

A certain substance is segmented in each segmentation cycle 5, 6 using a substance-specific segmentation criterion. In the image, the contrast agent, as the first substance, is imaged with CT numbers of less than −800 HU. In contrast thereto, stool remains are observed to have CT numbers of more than 300 HU. Therefore, these substances can be detected using a threshold of −800 HU and 300 HU, respectively. Hence, the entire contents of the intestines can be detected in two segmentation steps using two substance-specific segmentation criteria in the form of simple thresholding criteria.

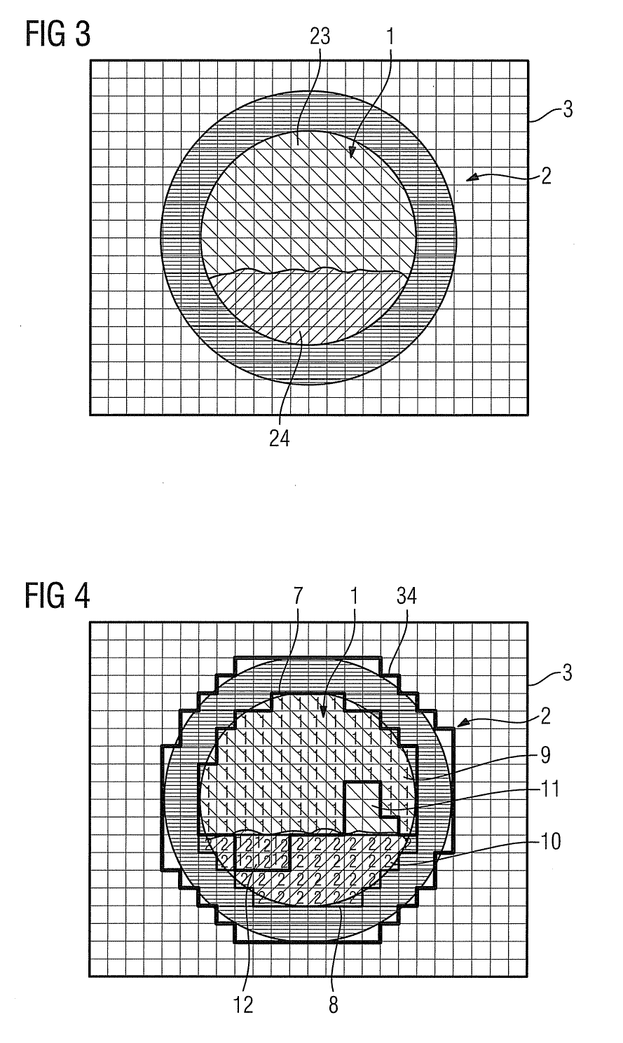

For improved visualization of the image regions 23, 24 belonging to different substances, the tomography scanner 4 furthermore has means for indexing the segmented portions 7, 8 illustrated in FIG. 4. In the process, each pixel in a segmented portion 7, 8 is assigned an index 9, 10 for characterizing a potential substance assignment. In the simplest case, the index corresponds to a number and characterizes the segmentation cycle 5, 6 in which the portion 7, 8 was segmented. By way of example, in FIG. 4, the pixels of the portion 7 segmented in the first cycle have been assigned the number ‘1’ as index 9. The pixels of the portion 8 segmented in the second cycle have been assigned the number ‘2’ as index 10. This indexing thus makes it possible to illustrate the image regions 23, 24 differently, which regions potentially can be assigned to a particular substance. This immediately allows the observer to identify different substance assignments in the image.

In order to explain the multistage segmentation, a flowchart of the method according to the invention is illustrated in FIG. 2.

A tomographic image 3, for example a slice or volume image, is generated in a first step 27 and the segmentation is carried out on the basis thereof. The multistage segmentation comprises a total of N individual segmentation cycles 5, 6, wherein a substance-specific segmentation criterion 25, 26, for example a thresholding criterion, is used to segment portions 7, 8 of different substances in each segmentation cycle 5, 6.

The segmented portions 7, 8 can have defects due to image noise, and these defects are closed by way of a closing method. In the closing method, morphological operators are used, wherein dilations and erosions are carried out iteratively in the segmented image. In order to close structures with a diameter of four pixels, e.g. two iterations for dilation and two for the erosion are carried out. Depending on the medical problem, the segmented portions 7, 8 are expanded by a certain number of pixels in order also to register as such a transition 34, which was not detected due to partial volume effects. This can also be performed by means of a morphological operator, namely a dilation operator.

In a subsequent indexing step 28, each pixel in the segmented portions 7, 8 is assigned an index 9, 10 for characterizing a potential substance assignment, which index represents the segmentation cycle 5, 6 in which the respective portion 7, 8 was segmented.

In order to eliminate overlap regions 12 with more than one index assignment or for closing missing regions 11 without index assignment between the segmented portions 7, 8 from different segmentation cycles 5, 6, the following post-processing steps are applied:

In a first post-processing step 29, the overlap regions 12 in which there is an overlap between segmented portions 7, 8 from different segmentation cycles 5, 6 are identified. An overlap is characterized in that a pixel was assigned at least two indices 9, 10 from different segmentation cycles 5, 6. In order to eliminate the overlap, only one index 9, 10 is selected from the index assignments and subsequently associated with the pixel. For this purpose, a boundary line for separating the adjoining portions 7, 8 is determined in the overlap region 12. By way of example, the boundary line can constitute a centerline within the overlap region 12. Expanding the segmented portions 7, 8 to the boundary line results in an assignment between the pixels arranged in the overlap region 12 and the adjoining portions 7, 8. This association is used as the basis for assigning the index 9, 10 from the multiple assignment. However, the multiple assignment can also be cleaned up as a function of a distance determined between the pixel and the portions 7, 8.

In a second post-processing step 30, missing regions 11 or gaps between the portions 7, 8 are filled. A missing region 11 is characterized in that a pixel was not assigned an index 9, 10 in any of the segmentation cycles 5, 6. The filling consists of assigning an index 9, 10 to the pixel in the missing region 11 from an adjacent portion 7, 8. The filling likewise can be determined in a corresponding fashion on the basis of a boundary line determined in the respective missing region 11. However, the filling is only brought about if the smallest determined distance from a neighboring portion 7, 8 is not greater than a predetermined threshold. This avoids structures situated too far away from inadvertently being assigned to a substance. Thus, this procedure takes into account the fact that the probability of a point situated a long distance away from belonging to the same substance is very small.

As a result of this segmentation, the tomographic image 3 should, in a visualization step 31, be displayed on a display unit 33, e.g. for a virtual colonography. By way of example, known techniques for volume rendering or known methods for the virtual flight through the hollow structure 2 to be examined are suitable for this. The indexing of the portions 7, 8 in this case serves to display the different substance assignment of the portions 7, 8 by means of corresponding coloring or different degrees of transparency. This makes it easy for the operator to distinguish, by observation, between the surfaces of the intestines to be examined and the stool-filled regions, i.e. the regions that should not be diagnosed.

In addition to visualization, it would likewise be conceivable for the portions 7, 8 to be evaluated automatically in a further-processing step 32. In the easiest case, the volumes of the segmented portions 7, 8, for example, can be determined. Moreover, the segmented portions 7, 8 can be examined further by post-processing. In particular, CAD programs, which automatically search for lesions and permit quantitative evaluations of lesions, e.g. the volumetric analysis of lesions, can be matched to the segmented surroundings by either specific algorithms or only specific parameterization.

In conclusion, the following statement can be made:

The multistage method according to an embodiment of the invention for segmenting an interior region 1 of a hollow structure 2 in a tomographic image 3 comprises at least two segmentation cycles 5, 6, wherein portions 7, 8 of the image are segmented in each cycle, respectively whilst using a substance-specific segmentation criterion. Using this procedure, the interior region 1 of the hollow structure 2 can be completely determined, even in the case where a plurality of substances with different imaging properties, e.g. with different attenuation properties, are present.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for segmenting an interior region of a hollow structure in a tomographic image, comprising:
respectively segmenting, in each of at least two segmentation cycles, portions of the interior region, each segmentation using a substance-specific segmentation criterion.

2. The method as claimed in claim 1, wherein the portions are indexed by assigning an index dependent on the cycle to each pixel in the respective portion for characterizing a potential substance assignment.

3. The method as claimed in claim 2, wherein the segmented portions are at least one of extended and closed by a prescribable number of iterations by way of morphological image operators.

4. The method as claimed in claim 3, wherein, after the segmentation cycles have passed, each pixel of a respective missing region without an index assignment is assigned an index from an adjoining portion in order to fill missing regions.

5. The method as claimed in claim 4, wherein, for the purposes of filling, the assignment is carried out dependent on a boundary line determined in the respective missing region for separating the adjoining portions.

6. The method as claimed in claim 4, wherein, for the purposes of filling, the assignment is carried out dependent on a determined distance of the pixel from the adjoining portions.

7. The method as claimed in claim 4, wherein the filling is only carried out if the smallest determined distance is not greater than a predetermined distance threshold.

8. The method as claimed in claim 1, wherein, after the segmentation cycles have passed, each pixel in overlap regions, where at least two indices are assigned to each pixel, has one index selected for it from the index assignments and it is only this selected index that is assigned to said pixel.

9. The method as claimed in claim 8, wherein, for the purposes of cleaning up, the assignment is carried out dependent on a boundary line, determined in the respective overlap region, for separating the adjoining portions.

10. The method as claimed in claim 8, wherein, for the purposes of cleaning up, the assignment is carried out dependent on the determined distance of the pixel from image regions of the portions without overlap.

11. The method as claimed in claim 1, wherein a thresholding criterion is used as substance-specific segmentation criterion.

12. The method as claimed in claim 11, wherein the thresholding criterion checks pixel-by-pixel whether an attenuation value assigned to the respective pixel lies within an attenuation value interval by comparison with an upper and lower threshold.

13. A tomography scanner for segmenting an interior region of a hollow structure in a tomographic image, comprising:
at least one device to segment portions of the interior region using a substance-specific segmentation criterion.

14. The tomography scanner as claimed in claim 13, further comprising:
at least one device to index the portions, by which every pixel in the portions are assignable to an index for characterizing a potential substance assignment, the segmenting and indexing being performed with different substance-specific segmentation criteria in a cyclical fashion.

15. The method as claimed in claim 1, wherein the segmented portions are at least one of extended and closed by a prescribable number of iterations by way of morphological image operators.

16. The method as claimed in claim 1, wherein, after the segmentation cycles have passed, each pixel of a respective missing region without an index assignment is assigned an index from an adjoining portion in order to fill missing regions.

17. The method as claimed in claim 1, wherein the filling is only carried out if the smallest determined distance is not greater than a predetermined distance threshold.

18. A tomography scanner for segmenting an interior region of a hollow structure in a tomographic image, comprising:
means for segmenting portions of the interior region using a substance-specific segmentation criterion;
means for indexing the portions, by which every pixel in the portions are assignable to an index for characterizing a potential substance assignment; and
means for performing the segmenting and indexing with different substance-specific segmentation criteria in a cyclical fashion.

19. The method as claimed in claim 1, wherein a tomography scanner is used for segmenting the interior region of the hollow structure in the tomographic image.

20. A computer readable medium including program segments for, when executed on a computer device, causing the computer device to implement the method of claim 1.
